(19) United States
(12) Patent Application Publication
(10) Pub. No.: US 2019/0017437 A1
(43) Pub. Date: Jan. 17, 2019

(54) CONTINUOUS DETONATION GAS TURBINE ENGINE

(71) Applicant: General Electric Company, Schenectady, NY (US)

(72) Inventors: Venkat Eswarlu Tangirala, Niskayuna, NY (US); Aaron Glaser, Cincinnati, OH (US); Sibtosh Pal, Mason, OH (US); Narendra Digamber Joshi, Niskayuna, NY (US)

(21) Appl. No.: 15/649,093

(22) Filed: Jul. 13, 2017

(51) Int. Cl. F02C 3/16; F02C 3/04; F01D 5/06; F01D 9/04; F02C 9/18; F23R 3/46

(52) U.S. Cl. CPC F02C 3/16; F02C 3/04; F01D 5/06; F05D 2240/35; F02C 9/18; F23R 3/46; F05D 2220/32; F01D 9/041

(57) ABSTRACT

A gas turbine engine includes a primary combustor, a secondary combustor, a high pressure (HP) turbine, and a mixing duct. The HP turbine is downstream of the primary combustor and fluidly connected to a rear end of the primary combustor via a first exhaust duct. The mixing duct is disposed downstream of the HP turbine and the secondary combustor. The mixing duct has a first inlet fluidly connected to the HP turbine via a turbine exit duct, a second inlet fluidly connected to a rear end of the secondary combustor via a second exhaust duct, and an outlet. The turbine exit duct directs a primary exhaust stream, which is emitted from the primary combustor and expanded through the HP turbine, into the mixing duct. The second exhaust duct directs a secondary exhaust stream emitted from the secondary combustor into the mixing duct.

### FIELD

The subject matter described herein relates to gas turbine engines.

### BACKGROUND

Conventional gas turbine engines rely upon deflagrative combustion to burn a fuel and air mixture and produce combustion gas products which travel at relatively slow rates and constant pressure within a combustion chamber. In order to increase thermal efficiency of gas turbine engines, modifications to the engine architecture are being studied in which the combustion occurs as a detonation in either a continuous (e.g., rotating) or pulsed mode. In detonative combustion, the ignited fuel and air mixture produces a pressure wave that transitions into a detonation wave (e.g., shock wave) moving at supersonic speeds. The detonative combustion reaction is driven by the detonation wave, as opposed to the deflagrative combustion reaction which is driven by heat. Detonative combustion propagates much faster than deflagrative combustion, and has a higher thermal efficiency of reaction than deflagration. The combustion products can be used to produce work, such as to power a turbine or produce thrust.

But, detonative combustion gas turbine engines are not without disadvantages. For example, the pulsed detonation configurations rely on periodically activating a system of valves at very high frequencies that are impractical to reliably control.

### SUMMARY

In one or more embodiments of the present disclosure, a gas turbine engine is provided that includes a primary combustor, a high pressure (HP) turbine, a secondary combustor, and a mixing duct. The primary combustor includes an annular combustion chamber extending between front and rear ends of the primary combustor. The high pressure (HP) turbine is downstream of the primary combustor and fluidly connected to the rear end of the primary combustor via a first exhaust duct. The first exhaust duct is positioned to direct a primary exhaust stream emitted from the primary combustor to the HP turbine. The secondary combustor includes an annular combustion chamber extending between front and rear ends of the secondary combustor. The mixing duct is disposed downstream of the HP turbine and the secondary combustor. The mixing duct has a first inlet fluidly connected to the HP turbine via a turbine exit duct, a second inlet fluidly connected to the rear end of the secondary combustor via a second exhaust duct, and an outlet. The turbine exit duct directs the primary exhaust stream from the HP turbine into the mixing duct, and the second exhaust duct directs a secondary exhaust stream emitted from the secondary combustor into the mixing duct.

In one or more embodiments of the present disclosure, a method of assembling a gas turbine engine is provided. The method includes providing a compressor upstream of a primary combustor that has an annular combustion chamber extending between front and rear ends of the primary combustor. The compressor is fluidly connected to the front end of the primary combustor via a primary air duct positioned to direct a first compressed air stream from the compressor to the primary combustor. The method includes providing a high pressure (HP) turbine downstream of the primary combustor and fluidly connected to the rear end of the primary combustor via a first exhaust duct. The method also includes providing a secondary combustor downstream of the compressor. The secondary combustor has an annular combustor chamber extending between front and rear ends of the secondary combustor. The front end of the secondary combustor is fluidly connected to the compressor via a bleed duct positioned to direct a second compressed air stream from the compressor to the secondary combustor. The method further includes providing a mixing duct downstream of both the HP turbine and the secondary combustor. The mixing duct includes a first inlet fluidly connected to the HP turbine via a turbine exit duct, a second inlet fluidly connected to the rear end of the secondary combustor via a second exhaust duct, and an outlet.

In one or more embodiments of the present disclosure, a gas turbine engine is provided that includes a primary combustor, a secondary combustor, a compressor, a high pressure (HP) turbine, and a mixing duct. Each of the primary combustor and the secondary combustor includes a respective annular combustion chamber extending between front and rear ends of the respective primary and secondary combustors. The compressor is disposed upstream of the primary and secondary combustors. The compressor extends between an inlet end and an outlet end, and includes multiple stages of rotor blades and stator vanes distributed in a high pressure section and a lower pressure section. The low pressure section is disposed upstream of the high pressure section between the inlet end and the high pressure section. The compressor is fluidly connected to the front end of the primary combustor via a primary air duct configured to direct a first compressed air stream to the primary combustor. The compressor is fluidly connected to the front end of the secondary combustor via a bleed duct configured to direct a different, second compressed air stream to the secondary combustor. The HP turbine is downstream of the primary combustor and fluidly connected to the rear end of the primary combustor via a first exhaust duct. The mixing duct is disposed downstream of the HP turbine and the secondary combustor. The mixing duct has a first inlet fluidly connected to the HP turbine via a turbine exit duct, a second inlet fluidly connected to the rear end of the secondary combustor via a second exhaust duct, and an outlet. The turbine exit duct directs the primary exhaust stream into the mixing duct, and the second exhaust duct directs a secondary exhaust stream emitted from the secondary combustor into the mixing duct.

### BRIEF DESCRIPTION OF THE DRAWINGS

The present inventive subject matter will be better understood from reading the following description of non-limiting embodiments, with reference to the attached drawings, wherein below:

FIG. 1 is a block diagram illustrating a continuous detonation gas turbine engine according to an embodiment;

FIG. 2 is a perspective view of a secondary combustor of the gas turbine engine according to an embodiment; and

FIG. 3 is a flow chart of a method for assembling a gas turbine engine according to an embodiment.

### DETAILED DESCRIPTION

Embodiments of the inventive subject matter described herein provide a continuous detonation gas turbine engine for providing power for propulsion and/or generating work for machinery. The continuous detonation gas turbine engine described herein includes a primary combustor and a secondary combustor staged in parallel. Each of the primary and secondary combustors receives a discrete fuel stream and a discrete compressed air stream. Furthermore, the primary and secondary combustors receive the associated compressed air streams directly from a compressor of the gas turbine engine, such that neither of the compressed air streams includes vitiated air. Each of the combustors includes an annular combustion chamber in which a fuel is mixed with compressed air and ignited to produce combustion products at elevated energy levels (e.g., elevated temperatures and pressures). The secondary combustor is a continuous or rotating detonation wave (RDW) combustor, such that the fuel and air mixture in the combustion chamber is continuously detonated by a respective detonation wave that propagates circumferentially around the annular combustion chamber. The primary combustor may also be an RDW combustor, but is not limited to being an RDW combustor. For example, the primary combustor alternatively may be configured to allow a deflagrative combustion reaction, instead of a detonative combustion reaction, within the annular combustion chamber.

The exhaust stream from the primary combustor, having expanded through a high pressure turbine of the gas turbine engine, is directed into a mixing duct. The exhaust stream from the secondary combustor is also directed into the mixing duct, and the two exhaust streams mix within the mixing duct. In an embodiment, the mixing duct does not receive a fresh fuel stream. A deflagrative combustion reaction may occur within the mixing duct due to non-combusted fuel received from one or both of the combustors. For example, the primary and secondary combustors may each have a corresponding fuel injector that provides an associated fuel stream into the respective combustor, but the mixing duct does not have a corresponding fuel injector. The mixing duct increases the power-to-fuel ratio (e.g., the amount of power produced for generating propulsive thrust or doing work per an overall amount of fuel consumed) of the gas turbine engine relative to omitting the mixing duct because additional energy in the form of heat is extracted without requiring additional fuel. For example, the mixing duct increases the residence time, allowing non-combusted reaction components in the exhaust streams to react.

At least one technical effect of the subject matter described herein includes reducing the weight and size of the gas turbine engine compared to conventional gas turbine engines able to produce a comparable amount of thrust.

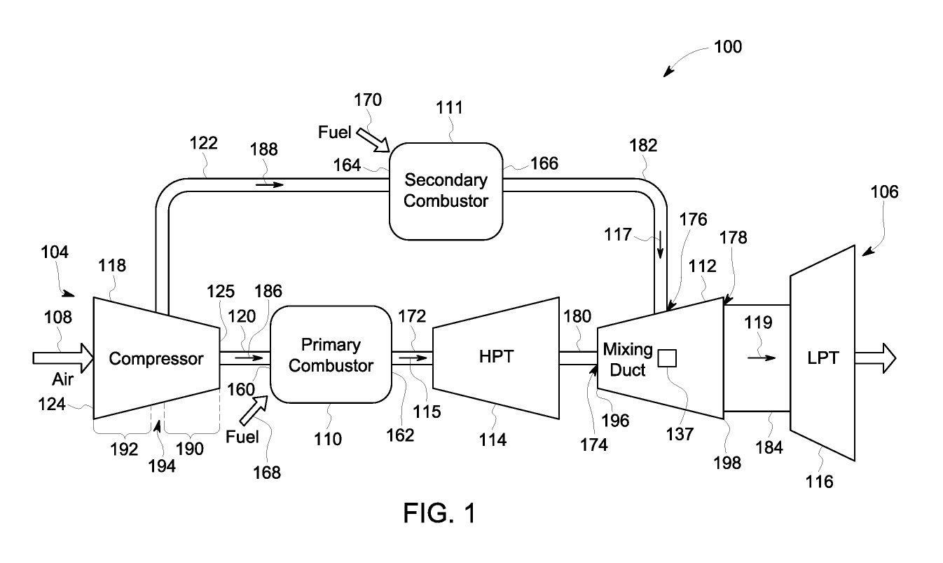

FIG. 1 is a block diagram illustrating a continuous detonation gas turbine engine 100 according to an embodiment. The gas turbine engine 100 includes multiple components arranged in series and parallel between a front 104 of the engine 100 and a rear 106 of the engine 100. During operation of the gas turbine engine 100, fluids flow in a downstream direction 108 from the front 104 towards the rear 106. Although not shown in FIG. 1, at least some of the components are held in fixed positions by a case or nacelle of the gas turbine engine 100 that at least partially surrounds the components.

In the illustrated embodiment, the gas turbine engine 100 includes a primary combustor 110 and a secondary combustor 111 that are staged in a parallel relationship. The primary combustor 110 has a front end 160 and an opposite, rear end 162. The secondary combustor 111 has a front end 164 and an opposite, rear end 166. Although not illustrated in FIG. 1, the primary and secondary combustors 110, 111 may each define an annular combustion chamber that extends between the front end 160, 164 and the rear end 162, 166 of the respective combustor 110, 111.

The gas turbine engine 100 includes a compressor 118 that is upstream of the primary combustor 110 and the secondary combustor 111. The compressor 118 extends between an inlet end 124 and an outlet end 125. The compressor 118 receives incoming ambient air from the environment through the inlet end 124. The compressor 118 compresses the incoming air to provide pressurized or compressed air to the primary and secondary combustors 110, 111. For example, the compressor 118 is fluidly connected to the front end 160 of the primary combustor 110 via a primary air duct 120. The compressor 118 is separately fluidly connected to the front end 164 of the secondary combustor 111 via a bleed duct 122. As used herein, the term “duct” may refer to any fluid passageway, and may be defined by adjacent walls of the same or different objects, a hose or pipe, a hole through a solid structure, or the like.

The primary air duct 120 directs a first compressed air stream 186 directly from the compressor 118 to the primary combustor 110. The bleed duct 122 directs a different, second compressed air stream 188 directly from the compressor 118 to the secondary combustor 111. In an embodiment, the first compressed air stream 186 supplied to the primary combustor 110 has a greater pressure than the second compressed air stream 188 supplied to the secondary combustor 111. For example, the compressor 118 includes a high pressure section 190 and a low pressure section 192. The low pressure section 192 is upstream of the high pressure section 190 between the inlet end 124 and the high pressure section 190. The incoming air flows through the low pressure section 192 prior to flowing through the high pressure section 190. In an embodiment, the bleed duct 122 is fluidly connected to the compressor 118 at an intermediate location 194 between the low pressure section 192 and the high pressure section 190. Therefore, the second compressed air stream 188 exits the compressor 118 via the bleed duct 122 after passing through the low pressure section 192 without passing through the high pressure section 190. The second compressed air stream 188 bypasses the high pressure section 190 of the compressor 118. The primary air duct 120 is fluidly connected to the outlet end 125 of the compressor 118, so the first compressed air stream 186 exits the compressor 118 after flowing through both the low pressure section 192 and the high pressure section 190. The first compressed air stream 186 has a greater pressure than the second compressed air stream 188 because the first compressed air stream 186 is compressed by the high pressure section 190 of the compressor 118, unlike the second compressed air stream 188 that bypasses the high pressure section 190. Although not show in the diagram on FIG. 1, the compressor 118 includes multiple stages of rotor blades and stator vanes distributed between the low pressure section 192 and the high pressure section 190.

The primary combustor 110 receives a first fuel stream 168 into the annular combustion chamber through the front end 160. Likewise, the secondary combustor 111 receives a second fuel stream 170 into the annular combustion chamber thereof through the front end 164. The first fuel stream 168 is discrete from the second fuel stream 170, although the two streams 168, 170 may be composed of the same type of fuel. In an embodiment, the secondary combustor 111 is an RDW combustor, and the annular combustion chamber thereof is configured to allow a detonation wave to move circumferentially therethrough to detonate the second fuel stream 170 with the second compressed air stream 188. The primary combustor 110 may also be an RDW combustor, or alternatively may be a deflagrative combustor such that the first fuel stream 168 burns with the first compressed air stream 186 in the annular combustion chamber of the primary combustor 110 via a deflagrative combustion reaction.

The rear end 162 of the primary combustor 110 is fluidly connected to a high pressure (HP) turbine 114 via a first exhaust duct 172. The HP turbine 114 receives an exhaust stream 115 (referred to herein as a primary exhaust stream) that is emitted from the primary combustor 110 through the first exhaust duct 172. The primary exhaust stream 115 includes reaction products from the combustion reaction (e.g., detonation or deflagration) that occurs within the primary combustor 110. The primary exhaust stream 115 has a raised temperature and pressure resulting from the exothermic combustion reaction. Although not shown in the diagram in FIG. 1, the HP turbine 114 includes one or more sets of rotor blades and may also include stator vanes axially between adjacent sets of rotor blades. The sets of rotor blades are coupled to a first shaft (not shown). The blades are fixed to the first shaft such that rotation of the rotor blades causes the first shaft to rotate about an axis. The first exhaust duct 172 is positioned to direct the primary exhaust stream 115 to the HP turbine 114. The primary exhaust stream 115 engages the rotor blades of the HP turbine 114, causing the HP turbine 114 (and the first shaft coupled thereto) to rotate. The rotation of the HP turbine 114 can be used to perform work. In an embodiment, the first shaft is coupled to the high pressure section 190 of the compressor 118. Therefore, the rotation of the HP turbine 114 is used to power the rotation of the blades along the high pressure section 190 via the first shaft. In addition, or alternatively, the rotation of the HP turbine 114 can be used for rotating a drive shaft for propelling a vehicle, powering a generator for generating electrical energy, or the like.

The gas turbine engine 100 further includes a mixing duct 112 downstream of the HP turbine 114. The mixing duct 112 has a front end 196 and an opposite rear end 198. The front end 196 is upstream of the rear end 198. The mixing duct 112 includes a first inlet 174, a second inlet 176, and an outlet 178. The outlet 178 is located at the rear end 198 of the duct 112. The first and second inlets 174, 176 are each located at (or proximate to) the front end 196. For example, the first and second inlets 174, 176 are each located closer to the front end 196 than to the rear end 198. The first inlet 174 is fluidly connected to the HP turbine 114 via a turbine exit duct 180. The primary exhaust stream 115 from the primary combustor 110 enters the turbine exit duct 180 after expanding through the HP turbine 114. The primary exhaust stream 115 enters the mixing duct 112 via the first inlet 174.

The mixing duct 112 is also downstream of the secondary combustor 111. The second inlet 176 of the mixing duct 112 is fluidly connected to the secondary combustor 111 via a second exhaust duct 182. The mixing duct 112 receives an exhaust stream 117 (referred to herein as a secondary exhaust stream) that is emitted from the secondary combustor 111 through the second exhaust duct 182. The secondary exhaust stream 117 includes reaction products from the detonation combustion reaction that occurs within the secondary combustor 111. The secondary exhaust stream 117 has a raised temperature and pressure resulting from the exothermic detonation combustion reaction. In an embodiment, the second exhaust duct 182 extends directly between the rear end 166 of the secondary combustor 111 and the second inlet 176. The second exhaust duct 182 is spaced apart from the HP turbine 114. Therefore, unlike the primary exhaust stream 115, the secondary exhaust stream 117 bypasses the HP turbine 114. The secondary exhaust stream 117 is conveyed directly to the mixing duct 112 upon exiting the secondary combustor 111.

The primary exhaust stream 115 mixes with the secondary exhaust stream 117 within the mixing duct 112. If present, non-combusted fuel within the primary exhaust stream 115 and/or the secondary exhaust stream 117 may combust with oxygen in the exhaust streams 115, 117 via a deflagrative combustion reaction within the mixing duct 112. The mixing duct 112 may have a size and dimension that allows the non-combusted fuel to combust therein. In an embodiment, the mixing duct 112 does not receive a supply of fresh fuel, unlike the primary and secondary combustors 110, 111 (which receive the fuel streams 168, 170, respectively). In an embodiment, a cross-sectional area of the mixing duct 112 is not uniform along the length of the mixing duct 112 between the front and rear ends 196, 198. For example, the cross-sectional area of the mixing duct 112 at the rear end 198 is greater than the cross-sectional area of the mixing duct 112 at the front end 196 in the illustrated embodiment.

The gas turbine engine 100 optionally includes a mixing device 137 disposed within the mixing duct 112. The mixing device 137 is configured to support mixing the primary exhaust stream received from the HP turbine with the secondary exhaust stream received from the secondary combustor. For example, the mixing device 137 may be an ejector device, such as a jet ejector, which uses the kinetic energy of the secondary exhaust stream as a driving fluid to suck in and entrain the primary exhaust stream, which has a lower pressure due to expanding through the HP turbine. Alternatively, the mixing device 137 may be other than an ejector device, such as a daisy mixer, a rotor, a series of mixing vanes, and/or the like.

In an embodiment, the gas turbine engine 100 further includes a low pressure (LP) turbine 116 disposed downstream of the mixing duct 112. The LP turbine 116 is fluidly connected to the outlet 178 of the mixing duct 112 via a discharge duct 184. The LP turbine 116 receives a mixed exhaust stream 119 that is emitted from the mixing duct 112 through the discharge duct 184. The mixed exhaust stream 119 is a combination of both the primary exhaust stream 115 and the secondary exhaust stream 117. Although not shown in the diagram in FIG. 1, the LP turbine 116 includes one or more sets of rotor blades and may also include stator vanes axially between adjacent sets of rotor blades. The sets of rotor blades are coupled to a second shaft (not shown), which differs from the first shaft coupled to the HP turbine 114. The blades of the LP turbine 116 are fixed to the second shaft such that rotation of the rotor blades causes the second shaft to rotate about an axis. The discharge duct 184 is positioned to direct the mixed exhaust stream 119 to the LP turbine 116.

The mixed exhaust stream 119 engages the rotor blades of the LP turbine 116, causing the LP turbine 116 (and the second shaft coupled thereto) to rotate. Like the HP turbine 114, the rotation of the LP turbine 116 can be used to perform work. In an embodiment, the second shaft is coupled to the low pressure section 192 of the compressor 118. Therefore, the rotation of the LP turbine 116 powers the rotation of the low pressure section 192 via the second shaft. In addition, or alternatively, the rotation of the LP turbine 116 can be used for rotating a drive shaft for propelling a vehicle, powering a generator for generating electrical energy, or the like.

After expanding through the LP turbine 116, the mixed exhaust stream 119 is discharged from the rear end 106 of the gas turbine engine 100. Although not shown in FIG. 1, the rear end 106 may include a tapered nozzle that provides thrust as the mixed exhaust stream 119 flows through the nozzle. In an alternative embodiment, the gas turbine engine 100 does not include the LP turbine 116, and the mixed exhaust stream 119 emitted from the outlet 178 is conveyed directly through a tapered nozzle to generate propulsive thrust.

Since the gas turbine engine 100 is illustrated as a block diagram in FIG. 1, it is understood that the sizes, shapes, and relative positions of the components illustrated in FIG. 1 are merely to support the description above and are not intended to limit the sizes, shapes, and/or positions of the components of the gas turbine engine 100 beyond the description above. For example, the ducts 120, 122, 172, and 182 are illustrated as having the same, uniform widths (although different lengths) in FIG. 1, but the ducts 120, 122, 172, 182 may have non-uniform and different widths. For example, the rear end 166 of the secondary combustor 111 in an embodiment may be located more proximate to the mixing duct 112 than the illustrated diagram represents, such that the second exhaust duct 182 is very short in length (e.g., less than 5 cm). It is also understood that the gas turbine engine 100 in various embodiments may include additional components not shown in FIG. 1.

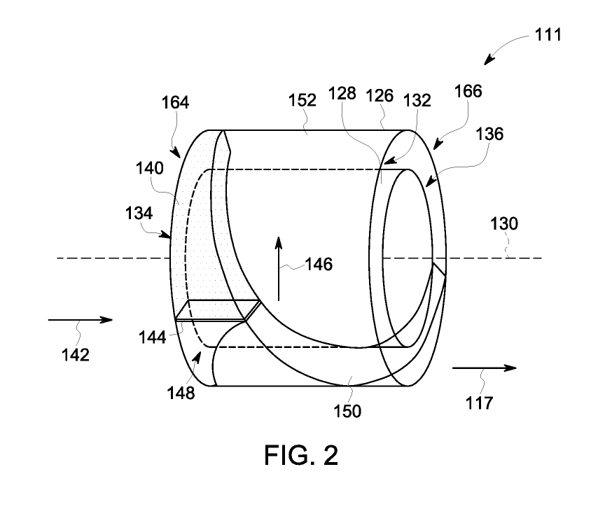

FIG. 2 is a perspective view of the secondary combustor 111 of the gas turbine engine 100 according to an embodiment. The secondary combustor 111 includes an annular outer wall 126 and an annular inner wall 128 that are both elongated between the front and rear ends 164, 166. The outer wall 126 and the inner wall 128 are oriented co-axially along a combustor axis 130. The inner wall 128 is spaced apart radially from the outer wall 126 (e.g., the inner wall 128 is radially interior of the outer wall 126) to define an annular combustion chamber 132 that extends between the front and rear ends 164, 166 along the axis 130. The combustion chamber 132 is cylindrical in the illustrated embodiment, but may have a frusto-conical shape or another shape in an alternative embodiment.

The secondary combustor 111 in FIG. 2 includes an annular opening 134 at the front end 164, and an annular opening 136 at the rear end 166. Alternatively, the secondary combustor 111 may include one or more holes or slots at the front and/or rear ends 164, 166 instead of annular openings. During operation of the combustor 111, a fresh fuel-and-air mixture 140 (representing the second fuel stream 170 and the second compressed air stream 188 moving in a rearward flow direction 142), enters the annular combustion chamber 132 through the annular opening 134. A detonation wave 144 travels circumferentially (in a tangential direction 146) within the annular combustion chamber 132. The detonation wave 144 ignites the fuel-and-air mixture 140, resulting in a high pressure region 148 and an expansion region 150 in the wake of the wave 144. The direction 146 of the detonation wave 144 is perpendicular to the flow direction 142. Since the detonation wave 144 moves circumferentially (instead of axially), the annular combustion chamber 132 may have a relatively compact size. For example, the axial length may be less than 50 cm, such as less than 20 cm. The annular combustion chamber 132 may have a radial gap thickness (between the inner wall 128 and the outer wall 126) that is less than 5 cm, such as less than 2 cm. Once the detonation combustion reaction is ignited, the reaction is self-sustaining.

The reaction products 152 from the detonation reaction are disposed rearward of the fresh mixture 140 and the detonation wave 144 in FIG. 2. The reaction products 152 move in the rearward flow direction 142 and are emitted from the annular combustion chamber 132 through the opening 136 as the secondary exhaust stream 117.

Although the combustor in FIG. 2 is described as the secondary combustor 111, the description may also apply to the primary combustor 110 in one or more embodiments in which the primary combustor 110 is also an RDW combustor.

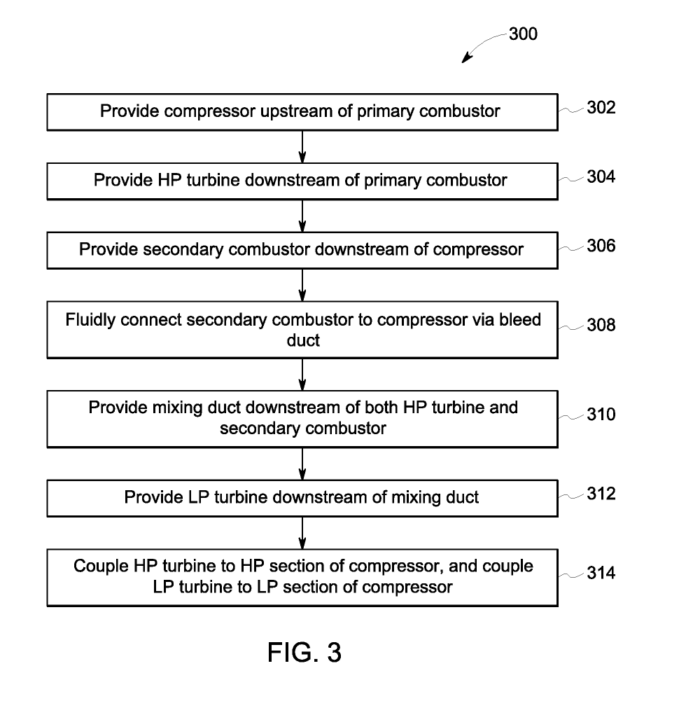

FIG. 3 is a flow chart of a method 300 for assembling a gas turbine engine. The gas turbine engine may be the gas turbine engine 100 shown in FIG. 1. At 302, a compressor is provided upstream of a primary combustor. The compressor and primary combustor may be loaded into a case or nacelle. The upstream location of the compressor is relative to a flow direction of fluid through the gas turbine engine, such that the fluid (e.g., air) flows through the compressor prior to entering the primary combustor. The primary combustor has an annular combustion chamber extending between front and rear ends of the primary combustor. The compressor extends between an inlet end and an outlet end and includes multiple stages of rotor blades distributed in a high pressure section and a lower pressure section. The low pressure section is disposed upstream of the high pressure section between the inlet end and the high pressure section. The compressor is fluidly connected to the front end of the primary combustor via a primary air duct positioned to direct a first compressed air stream from the compressor to the primary combustor. In an embodiment, the primary air duct is fluidly connected to the outlet end of the compressor. Therefore, the first compressed air stream flows through both the low pressure section and the high pressure section before entering the primary combustor.

At 304, a high pressure (HP) turbine is provided downstream of the primary combustor, such that the primary combustor is axially between the compressor and the HP turbine. The HP turbine is fluidly connected to the rear end of the primary combustor via a first exhaust duct. The HP turbine includes a set of rotor blades coupled to a first shaft.

At 306, a secondary combustor is provided downstream of the compressor. The secondary combustor has an annular combustion chamber extending between front and rear ends of the secondary combustor. The secondary combustor is a rotating detonation wave (RDW) combustor.

At 308, the front end of the secondary combustor is fluidly connected to the compressor via a bleed duct positioned to direct a second compressed air stream from the compressor to the secondary combustor. In an embodiment, the bleed duct is fluidly connected to an intermediate location of the compressor between the low pressure section and the high pressure section. Therefore, the second compressed air stream fed to the secondary combustor flows through the low pressure section of the compressor, but bypasses the high pressure section of the compressor.

At 310, a mixing duct is provided downstream of both the HP turbine and the secondary combustor. The mixing duct includes a first inlet, a second inlet, and an outlet. The first inlet is fluidly connected to the HP turbine via a turbine exit duct. The second inlet is fluidly connected to the rear end of the secondary combustor via a second exhaust duct. The mixing duct has a front end and an opposite rear end. The outlet is located at the rear end. The first and second inlets are each located at, or proximate to, the front end. The mixing duct may be formed such that a cross-sectional area of the mixing duct is greater at the rear end than at the front end. Optionally, a mixing device may be installed within the mixing duct to support mixing of exhaust streams received in the mixing duct through the first and second inlets. The mixing device may be an ejector device, a daisy mixer, a rotor, a series of stationary mixing vanes, and/or the like.

At 312, a low pressure (LP) turbine is provided downstream of the mixing duct. The (LP) turbine is fluidly connected to the outlet of the mixing duct. The LP turbine is configured to receive a mixed exhaust stream emitted from the outlet of the mixing duct. The LP turbine includes a set of rotor blades coupled to a second shaft that is different from the first shaft coupled to the HP turbine.

At 314, the HP turbine is coupled to the high pressure section of the compressor, and the LP turbine is coupled to the low pressure section of the compressor. For example, the first shaft is mechanically connected between the HP turbine and the high pressure section of the compressor, and the second shaft is mechanically connected between the LP turbine and the low pressure section of the compressor. Therefore, rotation of the HP turbine by the primary exhaust stream emitted from the primary combustor powers the rotation of the high pressure section of the compressor. In addition, rotation of the LP turbine by the mixed exhaust stream emitted from the mixing duct power the rotation of the low pressure section of the compressor.

In an embodiment, a gas turbine engine is provided that includes a primary combustor, a high pressure (HP) turbine, a secondary combustor, and a mixing duct. The primary combustor includes an annular combustion chamber extending between front and rear ends of the primary combustor. The high pressure (HP) turbine is downstream of the primary combustor and fluidly connected to the rear end of the primary combustor via a first exhaust duct. The first exhaust duct is positioned to direct a primary exhaust stream emitted from the primary combustor to the HP turbine. The secondary combustor includes an annular combustion chamber extending between front and rear ends of the secondary combustor. The mixing duct is disposed downstream of the HP turbine and the secondary combustor. The mixing duct has a first inlet fluidly connected to the HP turbine via a turbine exit duct, a second inlet fluidly connected to the rear end of the secondary combustor via a second exhaust duct, and an outlet. The turbine exit duct directs the primary exhaust stream from the HP turbine into the mixing duct, and the second exhaust duct directs a secondary exhaust stream emitted from the secondary combustor into the mixing duct.

Optionally, the secondary combustor is a rotating detonation wave (RDW) combustor configured to receive a fuel stream and a compressed air stream through the front end into the annular combustion chamber thereof. The annular combustion chamber of the secondary combustor is configured to allow a detonation wave to move circumferentially therethrough to detonate the fuel stream and the compressed air stream.

Optionally, the outlet of the mixing duct is fluidly connected to an inlet of a low pressure (LP) turbine. Optionally, the HP turbine includes a set of rotor blades coupled to a first shaft, and the LP turbine includes a set of rotor blades coupled to a different, second shaft.

Optionally, the gas turbine engine further includes a compressor disposed upstream of the primary and secondary combustors. The compressor is fluidly connected to the front end of the primary combustor via a primary air duct configured to direct a first compressed air stream to the primary combustor. The compressor is fluidly connected to the front end of the secondary combustor via a bleed duct configured to direct a different, second compressed air stream to the secondary combustor. Optionally, the first compressed air stream directed to the primary combustor has a greater pressure than the second compressed air stream directed to the secondary combustor.

Optionally, the compressor includes multiple stages of rotor blades distributed in a high pressure section and a lower pressure section. The low pressure section is disposed upstream of the high pressure section. The bleed duct is fluidly connected to the compressor at an intermediate location between the low pressure section and the high pressure section such that the second compressed air stream directed through the bleed duct to the secondary combustor bypasses the high pressure section of the compressor.

Optionally, a mixing device is disposed within the mixing duct to mix the primary exhaust stream from the HP turbine with the secondary exhaust stream from the secondary combustor within the mixing duct.

Optionally, the mixing duct has a front end and an opposite rear end. The outlet is located at the rear end. A cross-sectional area of the mixing duct is greater at the rear end than at the front end.

Optionally, the mixing duct has a size and dimension to allow non-combusted fuel in the primary exhaust stream and the secondary exhaust stream to combust within the mixing duct via deflagrative combustion.

In an embodiment, a method of assembling a gas turbine engine is provided. The method includes providing a compressor upstream of a primary combustor that has an annular combustion chamber extending between front and rear ends of the primary combustor. The compressor is fluidly connected to the front end of the primary combustor via a primary air duct positioned to direct a first compressed air stream from the compressor to the primary combustor. The method includes providing a high pressure (HP) turbine downstream of the primary combustor and fluidly connected to the rear end of the primary combustor via a first exhaust duct. The method also includes providing a secondary combustor downstream of the compressor. The secondary combustor has an annular combustor chamber extending between front and rear ends of the secondary combustor. The front end of the secondary combustor is fluidly connected to the compressor via a bleed duct positioned to direct a second compressed air stream from the compressor to the secondary combustor. The method further includes providing a mixing duct downstream of both the HP turbine and the secondary combustor. The mixing duct includes a first inlet fluidly connected to the HP turbine via a turbine exit duct, a second inlet fluidly connected to the rear end of the secondary combustor via a second exhaust duct, and an outlet.

Optionally, the mixing duct has a front end and an opposite rear end. The outlet is located at the rear end. The method further includes forming the mixing duct such that a cross-sectional area of the mixing duct is greater at the rear end than at the front end.

Optionally, the method further includes providing a low pressure (LP) turbine downstream of the mixing duct. The (LP) turbine is fluidly connected to the outlet of the mixing duct. Optionally, the HP turbine includes a set of rotor blades coupled to a first shaft, and the LP turbine includes a set of rotor blades coupled to a different, second shaft. The compressor includes multiple stages of rotor blades distributed in a high pressure section and a lower pressure section. The method further includes coupling the first shaft to the high pressure section of the compressor and coupling the second shaft to the low pressure section of the compressor.

Optionally, the method further includes providing a mixing device within the mixing duct for mixing a primary exhaust stream received in the mixing duct through the first inlet with a secondary exhaust stream received in the mixing duct through the second inlet.

Optionally, the compressor extends between an inlet end and an outlet end and includes multiple stages of rotor blades distributed in a high pressure section and a lower pressure section. The low pressure section is disposed upstream of the high pressure section between the inlet end and the high pressure section. The method includes fluidly connecting the bleed duct to an intermediate location of the compressor between the low pressure section and the high pressure section such that the second compressed air stream directed through the bleed duct to the secondary combustor bypasses the high pressure section of the compressor.

In an embodiment, a gas turbine engine is provided that includes a primary combustor, a secondary combustor, a compressor, a high pressure (HP) turbine, and a mixing duct. Each of the primary combustor and the secondary combustor includes a respective annular combustion chamber extending between front and rear ends of the respective primary and secondary combustors. The compressor is disposed upstream of the primary and secondary combustors. The compressor extends between an inlet end and an outlet end, and includes multiple stages of rotor blades and stator vanes distributed in a high pressure section and a lower pressure section. The low pressure section is disposed upstream of the high pressure section between the inlet end and the high pressure section. The compressor is fluidly connected to the front end of the primary combustor via a primary air duct configured to direct a first compressed air stream to the primary combustor. The compressor is fluidly connected to the front end of the secondary combustor via a bleed duct configured to direct a different, second compressed air stream to the secondary combustor. The HP turbine is downstream of the primary combustor and fluidly connected to the rear end of the primary combustor via a first exhaust duct. The mixing duct is disposed downstream of the HP turbine and the secondary combustor. The mixing duct has a first inlet fluidly connected to the HP turbine via a turbine exit duct, a second inlet fluidly connected to the rear end of the secondary combustor via a second exhaust duct, and an outlet. The turbine exit duct directs the primary exhaust stream into the mixing duct, and the second exhaust duct directs a secondary exhaust stream emitted from the secondary combustor into the mixing duct.

Optionally, the bleed duct is fluidly connected to the compressor at an intermediate location between the low pressure section and the high pressure section such that the second compressed air stream directed through the bleed duct to the secondary combustor bypasses the high pressure section of the compressor.

Optionally, the first compressed air stream directed from the compressor to the primary combustor has a greater pressure than the second compressed air stream directed from the compressor to the secondary combustor.

Optionally, the secondary combustor is a rotating detonation wave (RDW) combustor. The annular combustion chamber of the secondary combustor is configured to allow a detonation wave to move circumferentially therethrough to detonate the second compressed air stream with a fuel stream within the annular combustion chamber.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are example embodiments. Many other embodiments will be apparent to those of ordinary skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A gas turbine engine comprising:
a primary combustor including an annular combustion chamber extending between front and rear ends of the primary combustor;
a high pressure (HP) turbine downstream of the primary combustor and fluidly connected to the rear end of the primary combustor via a first exhaust duct, the first exhaust duct positioned to direct a primary exhaust stream emitted from the primary combustor to the HP turbine;
a secondary combustor including an annular combustion chamber extending between front and rear ends of the secondary combustor; and
a mixing duct disposed downstream of the HP turbine and the secondary combustor, the mixing duct having a first inlet fluidly connected to the HP turbine via a turbine exit duct, a second inlet fluidly connected to the rear end of the secondary combustor via a second exhaust duct, and an outlet, wherein the turbine exit duct directs the primary exhaust stream from the HP turbine into the mixing duct and the second exhaust duct directs a secondary exhaust stream emitted from the secondary combustor into the mixing duct.

2. The gas turbine engine of claim 1, wherein the secondary combustor is a rotating detonation wave (RDW) combustor configured to receive a fuel stream and a compressed air stream through the front end into the annular combustion chamber thereof, wherein the annular combustion chamber of the secondary combustor is configured to allow a detonation wave to move circumferentially therethrough to detonate the fuel stream and the compressed air stream.

3. The gas turbine engine of claim 1, wherein the outlet of the mixing duct is fluidly connected to an inlet of a low pressure (LP) turbine.

4. The gas turbine engine of claim 3, wherein the HP turbine includes a set of rotor blades coupled to a first shaft and the LP turbine includes a set of rotor blades coupled to a different, second shaft.

5. The gas turbine engine of claim 1, further comprising a compressor disposed upstream of the primary and secondary combustors, the compressor fluidly connected to the front end of the primary combustor via a primary air duct configured to direct a first compressed air stream to the primary combustor, the compressor fluidly connected to the front end of the secondary combustor via a bleed duct configured to direct a different, second compressed air stream to the secondary combustor.

6. The gas turbine engine of claim 5, wherein the first compressed air stream directed to the primary combustor has a greater pressure than the second compressed air stream directed to the secondary combustor.

7. The gas turbine engine of claim 5, wherein the compressor includes multiple stages of rotor blades distributed in a high pressure section and a lower pressure section, the low pressure section disposed upstream of the high pressure section, the bleed duct fluidly connected to the compressor at an intermediate location between the low pressure section and the high pressure section such that the second compressed air stream directed through the bleed duct to the secondary combustor bypasses the high pressure section of the compressor.

8. The gas turbine engine of claim 1, wherein the a mixing device is disposed within the mixing duct to mix the primary exhaust stream from the HP turbine with the secondary exhaust stream from the secondary combustor within the mixing duct.

9. The gas turbine engine of claim 1, wherein the mixing duct has a front end and an opposite rear end, the outlet located at the rear end, wherein a cross-sectional area of the mixing duct is greater at the rear end than at the front end.

10. The gas turbine engine of claim 1, wherein the mixing duct has a size and dimension to allow non-combusted fuel in the primary exhaust stream and the secondary exhaust stream to combust within the mixing duct via deflagrative combustion.

11. A method comprising:
providing a compressor upstream of a primary combustor that has an annular combustion chamber extending between front and rear ends of the primary combustor, the compressor fluidly connected to the front end of the primary combustor via a primary air duct positioned to direct a first compressed air stream from the compressor to the primary combustor;
providing a high pressure (HP) turbine downstream of the primary combustor and fluidly connected to the rear end of the primary combustor via a first exhaust duct;
providing a secondary combustor downstream of the compressor, the secondary combustor having an annular combustion chamber extending between front and rear ends of the secondary combustor, the front end of the secondary combustor fluidly connected to the compressor via a bleed duct positioned to direct a second compressed air stream from the compressor to the secondary combustor; and
providing a mixing duct downstream of both the HP turbine and the secondary combustor, the mixing duct including a first inlet fluidly connected to the HP turbine via a turbine exit duct, a second inlet fluidly connected to the rear end of the secondary combustor via a second exhaust duct, and an outlet.

12. The method of claim 11, wherein the mixing duct has a front end and an opposite rear end, the outlet located at the rear end, the method further comprising forming the mixing duct such that a cross-sectional area of the mixing duct is greater at the rear end than at the front end.

13. The method of claim 11, further comprising providing a low pressure (LP) turbine downstream of the mixing duct, the (LP) turbine fluidly connected to the outlet of the mixing duct.

14. The method of claim 13, wherein the HP turbine includes a set of rotor blades coupled to a first shaft and the LP turbine includes a set of rotor blades coupled to a different, second shaft, the compressor including multiple stages of rotor blades distributed in a high pressure section and a lower pressure section, wherein the method further comprises coupling the first shaft to the high pressure section of the compressor and coupling the second shaft to the low pressure section of the compressor.

15. The method of claim 11, further comprising providing a mixing device within the mixing duct for mixing a primary exhaust stream received in the mixing duct through the first inlet with a secondary exhaust stream received in the mixing duct through the second inlet.

16. The method of claim 11, wherein the compressor extends between an inlet end and an outlet end and includes multiple stages of rotor blades distributed in a high pressure section and a lower pressure section, the low pressure section disposed upstream of the high pressure section between the inlet end and the high pressure section, wherein the method includes fluidly connecting the bleed duct to an intermediate location of the compressor between the low pressure section and the high pressure section such that the second compressed air stream directed through the bleed duct to the secondary combustor bypasses the high pressure section of the compressor.

17. A gas turbine engine comprising:
a primary combustor and a secondary combustor, each of the primary and secondary combustors including a respective annular combustion chamber extending between front and rear ends of the respective primary and secondary combustors;
a compressor disposed upstream of the primary and secondary combustors, the compressor extending between an inlet end and an outlet end and includes multiple stages of rotor blades and stator vanes distributed in a high pressure section and a lower pressure section, the low pressure section disposed upstream of the high pressure section between the inlet end and the high pressure section, the compressor fluidly connected to the front end of the primary combustor via a primary air duct configured to direct a first compressed air stream to the primary combustor, the compressor fluidly connected to the front end of the secondary combustor via a bleed duct configured to direct a different, second compressed air stream to the secondary combustor;
a high pressure (HP) turbine downstream of the primary combustor and fluidly connected to the rear end of the primary combustor via a first exhaust duct; and
a mixing duct disposed downstream of the HP turbine and the secondary combustor, the mixing duct having a first inlet fluidly connected to the HP turbine via a turbine exit duct, a second inlet fluidly connected to the rear end of the secondary combustor via a second exhaust duct, and an outlet, wherein the turbine exit duct directs the primary exhaust stream into the mixing duct and the second exhaust duct directs a secondary exhaust stream emitted from the secondary combustor into the mixing duct.

18. The gas turbine engine of claim 17, wherein the bleed duct is fluidly connected to the compressor at an intermediate location between the low pressure section and the high pressure section such that the second compressed air stream directed through the bleed duct to the secondary combustor bypasses the high pressure section of the compressor.

19. The gas turbine engine of claim 17, wherein the first compressed air stream directed from the compressor to the primary combustor has a greater pressure than the second compressed air stream directed from the compressor to the secondary combustor.

20. The gas turbine engine of claim 17, wherein the secondary combustor is a rotating detonation wave (RDW) combustor and the annular combustion chamber of the secondary combustor is configured to allow a detonation wave to move circumferentially therethrough to detonate the second compressed air stream with a fuel stream within the annular combustion chamber.
